(19) United States
(12) Patent Application Publication
(10) Pub. No.: US 2009/0128357 A1
(43) Pub. Date: May 21, 2009

(54) NETWORK AUDIO/VIDEO RESCUE SYSTEM

(75) Inventors: Jui-Hsu Shen, Taichung City (TW); His-Chuan Liu, Taichung City (TW); Ju-Lung Chen, Taichung City (TW); Tsung-Ching Lin, Taipei City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignees: TWSAFE INC., Taichung City (TW); I-SHOU UNIVERSITY, KAOHSIUNG COUNTY (TW)

(21) Appl. No.: 11/942,244

(22) Filed: Nov. 19, 2007

(51) Int. Cl. G08B 5/22; H04N 7/18

(52) U.S. Cl. 340/825.36; 348/61; 348/E05.024

(57) ABSTRACT

A network audio/video (AV) rescue system is provided, which includes more then one rescue terminals, and each rescue terminal transmits signals with a server through a same protocol. When a rescue terminal is activated by a local user, image and audio signals can be transmitted for calling a rescue. A server can immediately receive the image and audio signals and determine the network address of the rescue terminal sending the signals. Therefore, a remote user on the server end can communicate with the local user through the server, such that the remote user can know what is needed for the local user and to provide necessary help and assistance to the local user.

### BACKGROUND OF THE INVENTION

1. Field of the Invention

The present invention relates to a rescue system, especially for an audio/video rescue system transmitting signals through network connections.

2. Related Art

Referring FIG. 4, a conventional emergency rescue system includes more than one terminal 50 and a server 70, wherein each terminal 50 can be installed in different locations, such as in different buildings; however, the server 70 is installed in a security room of another building, and connected with each terminal 50. The signal transmissions between the terminals 50 and the server 70 are transmitted through traditional telephone networks. Hence, when a user activates or touches one of the terminals 50 for calling a rescue, the terminal 50 has to pass through the telephone networks to connect to a telephone exchange 60 of a Telcom office. And the server 70 is connected to the telephone exchange 60 of the Telcom office as well. Therefore, the server 70 can obtain the rescue signals sent from the terminal 50 through the telephone exchange 60.

However, there might be a lot of users installing the terminal 50, and the areas where the users are located might link to different telephone exchanges 60. Therefore, when the server 70 is needed to determine the location of the terminal 50 sending a rescue signal, the telephone exchange 60 connecting to the terminal 50 must firstly be screened out, and then which terminal 50 sending the rescue signal is further determined, so the whole confirmation process is quite complicated.

Moreover, owing to the signals sent from the terminal 50 is transmitted through the traditional telephone networks, an additional audio/video (AV) capture/encode device is further required to connect with the terminal 50 if the signal transmission is involved with audio or video signals, led to problems associated with inconvenience in use and cost increasing.

### SUMMARY OF THE INVENTION

Accordingly, the present invention is directed to a network audio/video (AV) rescue system to solve the problems of complicated screening process and requiring additional AV capture/encode devices for AV signal transmission, which has led to inconvenience in use and cost increasing for the users of the conventional emergency rescue system. The network AV rescue system comprises more then one rescue terminals, each rescue terminal comprising a process unit; a memory unit, which is bi-directional linked with the process unit to process data reading and data writing controlled by the process unit; an alarm unit, which is bi-directional linked with the process unit and used to activate the process unit by a local user, and the alarm unit can send out an alarm signal controlled by the process unit; a video input unit, which is bi-directional linked with the process unit and used to capture surrounding images to generate a video signal, and the video signal is then sent to the process unit; an audio input/output (I/O) unit, which is bi-directional linked with the process unit and used to receive and convert the user's voice to be an audio signal; the audio signal is then sent to process unit, and the audio I/O unit can be controlled by the process unit to output voice signals; and a network interface unit, which is bi-directional linked with the process unit, and the network interface unit is controlled by the process unit to send out an output signal; and a server, which transmits signals with each rescue terminal through a same protocol, such that each terminal and the server has its specific network address. The server can therefore determine which rescue terminal sending the rescue signal according to the network address; the server comprises a server process unit; a server network interface, which is bi-directional linked with the server process unit and used to receive the output signal of the rescue terminal, and the server network interface can send the output signal to the server process unit; and an input/output (I/O) unit, which is bi-directional linked with the server process unit and used to receive and output voice and video signals; that is, the voice and images of a remote user in the server end can be transmitted to the rescue terminal through the server process unit and the server network interface, and the local user of the rescue terminal can communicate with the remote user by the I/O unit.

Because the signals between each rescue terminal and the server are transmitted through a network protocol, each terminal has; therefore, its own network address. Hence, when any one of the rescue terminals sends out an output signal to the server, the server can determine the location of the rescue terminal according to its network address. Besides, the audio and video signals sent by the rescue terminal can be also obtained so as to proceed audio and video communications between the server and the rescue terminal, such that the convenience in use can be increased and cost can be decreased.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a systematic diagram of a prefer embodiment according to the present invention;

FIG. 2 is a systematic block diagram of a rescue terminal according to the present invention;

FIG. 3 is a systematic block diagram of a server according to the present invention; and

FIG. 4 is a systematic diagram of a conventional emergency rescue system.

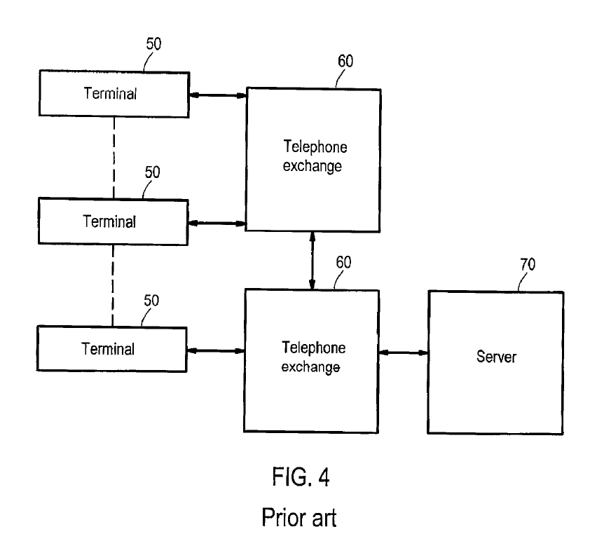

### DETAILED DESCRIPTION OF THE INVENTION

Hereinafter, the embodiment will be described with reference to accompanying drawings.

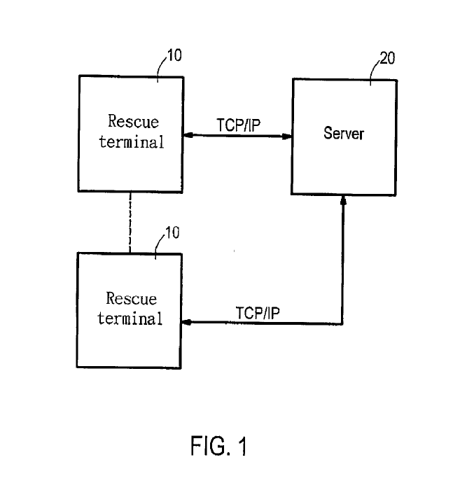

Referring to FIG. 1, it is a prefer embodiment of the present invention. The network A/V rescue system of the present invention comprises more than one rescue terminal 10 and a server 20. For easy explanation, in the embodiment, only one rescue terminal is taken as example. The rescue terminal 10 and the server 20 use a same network protocol for signal transmission, such as TCP/IP (Transmission Control Protocol/Internet Protocol); therefore, each rescue terminal 10 and the server 20 has its own specific network address. In addition, the rescue terminals 10 and the server 20 can be linked through a physical network or a wireless network to transmit signals.

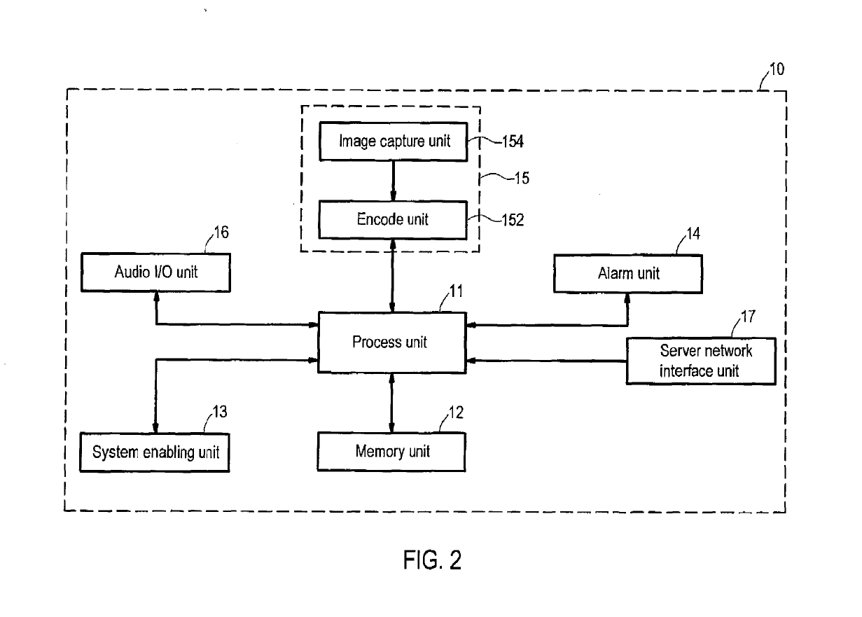

Referring to FIG. 2, the rescue terminal 10 comprises a process unit 11 and a plurality of units which are respectively bi-directional linked with the process unit 11. The plural units include a memory unit 12, a system enabling unit 13, an alarm unit 14, a video input unit 15, an audio input/output unit 16, and a network interface unit 17. Wherein, the video input unit 15 includes an encode unit 152 and an image capture unit 154. The encode unit 152 and the process unit are bi-directional linked, and the output end of the image capture unit 154 is linked to the input end of the encode unit 152.

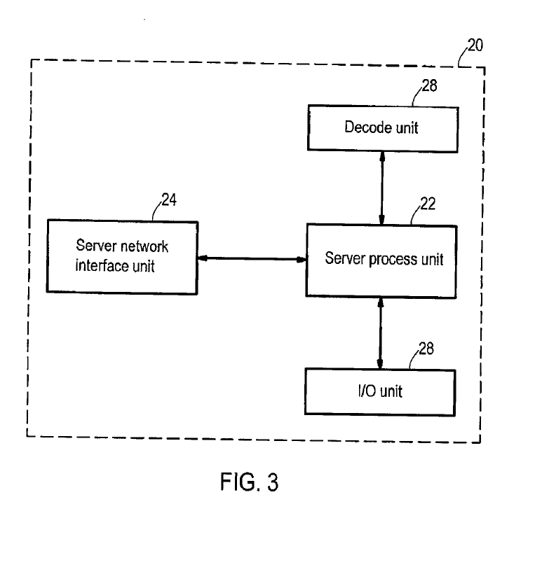

Referring to FIG. 3, the server 20 comprises a server process unit 22 and a plurality of units which are respectively bi-directional linked to the server process unit 22. The plural units include a server network interface unit 24, an input/output (I/O) unit 26, and a decode unit 28.

In practice, a local user can turn on the rescue terminal 10 through the system enabling unit 13. After the rescue terminal 10 is turned on, the video input unit 15 and the audio I/O unit 16 may continuously record the surroundings of the local user and receive external voice.

Whenever a local user of a rescue terminal 10 is calling a rescue help, the local user can touch the alarm unit 14 to activate the process unit 11. At this moment, the alarm unit 14 is controlled by the process unit 11 to send out an alarm signal. And the process unit 11 sends out a rescue signal through the network interface unit 17 to the server. In the meantime, after activating, the process unit 11 starts to receive video signals from the video input unit 15 by shooting the surroundings of the local user, wherein surrounding images of where the user is located have taken by the image capture unit 154, and the images are transmitted to the encode unit 152 for encoding and then sent to the process unit 11 by the video input unit 15. Wherein, the image capture unit 154 can be a video camera or a light-sensing element such as a charge-coupled device (CCD) or a complementary metal-oxide-semiconductor (CMOS) and so on.

When the process unit 11 receives the image signals sent from the video input unit 15, the memory unit 12 is utilized to temporarily save the image signals. At the same time, the network interface unit 17 is also utilized to send the image signals saved in the memory unit 12 to the server 20.

Once receiving the image signals, the server network interface unit 24 transmits the image signals to the server process unit 22. The server process unit 22 further transmits the image signals to the decode unit 28 for decoding. The decode unit 28 then transmits the decoded image signals to the I/O unit 26 by the server process unit 22. Therefore, an on-duty remote user on duty can obtain the rescue signal and the surrounding image signals from the I/O unit 26. Wherein, the I/O unit 26 includes a monitor, a microphone, or any A/V input/output device.

In addition, the remote user may use the I/O unit 26 to have bi-directional communications with the local user. Wherein, the local user can communicate with the remote user by the audio I/O unit 16; in addition, the remote user can also proceed signal transmissions through the I/O unit 26 and the rescue terminal 10, and remote control the alarm unit 14 to send an alarm so as to achieve a warning or deterrent effect.

Besides, the signal transmissions between the rescue terminal 10 and the server 20 are transmitted by TCP/IP, so that each rescue terminal 10 has its specific network address (IP address) and each package of the signal transmissions between the rescue terminal 10 and the server 20 contains the IP address of the transmitting end. Therefore, when the server 20 is linked to a plurality of the rescue terminals 10 and it receives a rescue signal from a specific rescue terminal 10, the server 20 can immediately determine that the rescue signal is coming from which rescue terminal 10, such that rescue persons can reach there for rescue.

The alarm unit 14 may further include more than one digital input/output (I/O) ports. Wherein, the digital I/O port can be an RS232 port or RS485 port. The digital I/O ports can respectively be connected to different devices with specific functions, such that the rescue terminal 10 can have additional functions. For example, the digital I/O port may connect to a passive infrared sensor (PIR), Reed Switch, or electronic password lock, so that the rescue terminal 10 can have functions of avoiding being damaged or turned off by other people. In addition, the digital I/O port can be an interface for connecting with other devices, for example, computers, ratable camera platforms, or programmable logic controllers and so on. If the digital I/O port is connected with a computer taken as an example, the rescue terminal 10 can have data communications or functional controls with the computer through the digital I/O port.

Hereby, the I/O unit 26 of the server 20 can immediately display the surrounding status of the rescue terminal 10. Besides, through the audio I/O unit 16, the remote user on the server end can directly communicate with the local user sending rescue signals from the rescue terminal 10, so as to provide necessary help.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A network audio/video rescue system, comprising:
more then one rescue terminals, each rescue terminal including:
a process unit;
a memory unit, being bi-directional linked with the process unit to process data reading and data writing controlled by the process unit;
an alarm unit, being bi-directional linked with the process unit and used to activate the process unit by a local user; and the alarm unit sends out an alarm signal controlled by the process unit;
a video input unit, being bi-directional linked with the process unit and used to capture surrounding images to generate a video signal sent to the process unit;
an audio input/output (I/O) unit, being bi-directional linked with the process unit and used to receive and convert the local user's voice to be an audio signal; the audio signal is then sent to the process unit, and the audio I/O unit is controlled by the process unit to output voice signals; and
a network interface unit, being bi-directional linked with the process unit and controlled by the process unit to send out an output signal; and
a server, transmitting signals with each rescue terminal through a same protocol, such that each rescue terminal and the server has its specific network address; the server determines which rescue terminal sending a rescue signal according to the network address; the server comprising:
a server process unit;
a server network interface, being bi-directional linked with the server process unit and used to receive the output signal from the rescue terminal; and the server network interface sends the output signal to the server process unit; and
an input/output (I/O) unit, being bi-directional linked with the server process unit and used to receive and output audio and video signals; voice and images of a remote user in the server end are transmitted to the rescue terminal sending the rescue signal through the server process unit and the server network interface, and the local user of the rescue terminal can communicate with a remote user by the I/O unit.

2. The network audio/video rescue system as claimed in claim 1, wherein the video input unit includes an encode unit and an image capture unit, the encode unit and the process unit being bi-directional linked and an output end of the image capture unit being linked to the encode unit; the video signal is coded by the encode unit.

3. The network audio/video rescue system as claimed in claim 2, wherein the rescue terminal further includes a system enabling unit being bi-directional linked with the process unit and used to turn on the rescue terminal.

4. The network audio/video rescue system as claimed in claim 3, wherein the server includes a decode unit; the decode unit is bi-directional linked to the server process unit for decoding the output signal, and transmits the decoded output signal to the server process unit.

5. The network audio/video rescue system as claimed in claim 1, wherein the image capture unit is a charge-coupled device (CCD) or a complementary metal-oxide-semiconductor (CMOS).

6. The network audio/video rescue system as claimed in claim 2, wherein the image capture unit is a charge-coupled device (CCD) or a complementary metal-oxide-semiconductor (CMOS).

7. The network audio/video rescue system as claimed in claim 3, wherein the image capture unit is a charge-coupled device (CCD) or a complementary metal-oxide-semiconductor (CMOS).

8. The network audio/video rescue system as claimed in claim 4, wherein the image capture unit is a charge-coupled device (CCD) or a complementary metal-oxide-semiconductor (CMOS).

9. The network audio/video rescue system as claimed in claim 5, wherein the alarm unit includes more than one digital input/output port.

10. The network audio/video rescue system as claimed in claim 6, wherein the alarm unit includes more than one digital input/output port.

11. The network audio/video rescue system as claimed in claim 7, wherein the alarm unit includes more than one digital input/output port.

12. The network audio/video rescue system as claimed in claim 8, wherein the alarm unit includes more than one digital input/output port.

13. The network audio/video rescue system as claimed in claim 9, wherein the digital input/output port is connected with a computer, a passive infrared sensor (PIR), a Reed switch, an electronic password lock, a programmable logic controller, or a ratable camera platform.

14. The network audio/video rescue system as claimed in claim 10, wherein the digital input/output port is connected with a computer, a passive infrared sensor (PIR), a Reed switch, an electronic password lock, a programmable logic controller, or a ratable camera platform.

15. The network audio/video rescue system as claimed in claim 11, wherein the digital input/output port is connected with a computer, a passive infrared sensor (PIR), a Reed switch, an electronic password lock, a programmable logic controller, or a ratable camera platform.

16. The network audio/video rescue system as claimed in claim 12, wherein the digital input/output port is connected with a computer, a passive infrared sensor (PIR), a Reed switch, an electronic password lock, a programmable logic controller, or a ratable camera platform.
